(19) United States
(12) Patent Application Publication
(10) Pub. No.: US 2013/0262787 A1
(43) Pub. Date: Oct. 3, 2013

(54) SCALABLE MEMORY ARCHITECTURE FOR TURBO ENCODING

(71) Applicants: Venugopal Santhanam, Bangalore (IN); Krushna Prasad Ojha, Jajpur (IN); Pratap Neelasheety, Raichur (IN); Lokesh Kabra, Bangalore (IN)

(72) Inventors: Venugopal Santhanam, Bangalore (IN); Krushna Prasad Ojha, Jajpur (IN); Pratap Neelasheety, Raichur (IN); Lokesh Kabra, Bangalore (IN)

(21) Appl. No.: 13/539,368

(22) Filed: Jun. 30, 2012

(30) Foreign Application Priority Data
Mar. 28, 2012 (IN) 1199/CHE/2012

(51) Int. Cl. G06F 12/00

(52) U.S. Cl. 711/148; 711/E12.001

(57) ABSTRACT

Low-power, easily scalable architectures for high-speed data handling are critical to modern circuits and systems. Successful architectures must provide efficient data storage and efficient/flexible data retrieval with low power consumption. Data encoding, including that achieved with turbo codes, have data streams split into a sequence of even and odd data bits. These bits are written into multiple single-port memories so that the writing alternates between memories. Scheduling for the reading and writing is performed to avoid conflicts and give priority to the read operations.

### RELATED APPLICATIONS

This application claims the benefit of Indian provisional patent application “Optimal Low Power and Scalable Memory Architecture for Turbo Encoder” Ser. No. 1199/CHE/2012, filed Mar. 28, 2012. The foregoing application is hereby incorporated by reference in its entirety.

### FIELD OF INVENTION

This application relates generally to memory architectures and more particularly to low power and scalable memory architectures for turbo encoding.

### BACKGROUND

The complexity of modern data handling applications demands that the systems which implement these applications must meet key design and architecture criteria. These criteria typically specify high performance systems that are also highly reliable and power efficient that may be adapted to a variety of applications areas. In the context of communications architectures such implemented systems require low power consumption in order to conserve the limited battery power of ubiquitous handheld communication devices. Further, the increasing demands of communications standards and data throughput requirements motivate ever-higher operating speed, lower power consumption, and more accurate data processing and transmission. In order to meet these—at times—divergent requirements, data encoding has often been employed to both ensure data integrity and maximize information throughput.

Many data encoding schemes exist. The choice of a particular encoding scheme hinges on the selection and implementation of a scheme that is both computationally efficient and able to take maximum advantage of the available communications channel. To this end, a class of encoders called Forward Error Correction (FEC) or Channel Coding (CD) encoders has been developed. These encoders allow for the control of bit-error rates in communications channels. Specifically, such encoding schemes support some error detection and correction (EDC) of data transmitted over an unreliable or noisy communications channel. These encoders typically introduce small amounts of redundancy into the data that is being transmitted. These redundant bits function by allowing the receiver to cross check the data to verify that the data received is actually correct.

### SUMMARY

Data manipulation systems need memory architectures which are capable of high speed operation, are power efficient, and which are readily scaled to a wide range of applications. A computer-implemented method for data manipulation is disclosed comprising: receiving a data stream; splitting the data stream into a sequence of even bits and odd bits; writing data from the sequence of even bits and odd bits to a plurality of single-port memories wherein the writing alternates the even bits and the odd bits among the plurality of single-port memories; reading from the plurality of single-port memories wherein the reading gathers data bits from among the plurality of single-port memories; and scheduling the writing and reading operations to avoid conflicts. The data stream may comprise a communications stream. The communications stream may be one of 3GPP LTE, IEEE standard for LAN, and IEEE standard for MAN. The data stream may include encoding. The encoding may include a turbo code. The even bits and the odd bits may be stored in a natural order. The data stream may be divided into blocks. A block size, into which the data stream is divided, may be determined based on a communications standard. The plurality of single-port memories may comprise two single-port memories. The two single-port memories may be of size equal to one half a maximum block size based on a communications standard. Data packing may be performed on data blocks into which the data stream is divided. Bits with even indices may be written into a first single-port memory and bits with odd indices may be written into a second single-port memory. The bits with the even indices may be stored in a first shift register and the bits with the odd indices may be stored in a second shift register. Data selection may read the data stream in interleaved order. The reading of the data for natural order addressing and the reading of the data for interleaved order addressing may occur simultaneously. The reading of the data for natural order addressing and the reading of the data for interleaved order addressing may occur in different memories among the plurality of single-port memories wherein the different memories are comprised of an even memory and an odd memory. A read operation and a write operation may take place simultaneously wherein the read operation and the write operation occur in different memories among the plurality of single-port memories wherein the different memories are comprised of an even memory and an odd memory. An interleaved read operation may have priority over a natural read which has priority over a write operation. A read operation may cause a delay in a write operation in order to avoid a conflict. Data from the write operation, which is delayed, may be backed up locally and then written to one of the plurality of single-port memories. The data stream may be continuous and the write operation is delayed while a read operation occurs. An output data stream may be continuous though the write operation is delayed while a read operation occurs.

In embodiments, an apparatus for data manipulation may comprise: a plurality of single-port memories; a splitter, coupled to the plurality of single-port memories, wherein a data stream which is received is split by the splitter and written into the plurality of single-port memories so that bits are alternated among the plurality of single-port memories and wherein the bits are alternated such that even bits and odd bits are alternated among the plurality of single-port memories; a bit extractor which reads data from the plurality of single-port memories; and a scheduler which schedules reads and writes of the plurality of single-port memories to avoid conflicts. In some embodiments, a computer implemented method for circuit implementation may comprise: including a plurality of single-port memories; coupling a splitter to the plurality of single-port memories, wherein a data stream which is received is split by the splitter and written into the plurality of single-port memories and wherein bits are alternated such that even bits and odd bits are alternated among the plurality of single-port memories; coupling a bit extractor which reads data from the plurality of single-port memories; and coupling a scheduler which schedules reads and writes of the plurality of single-port memories to avoid conflicts. In embodiments, a computer system for circuit implementation may comprise: a memory which stores instructions; one or more processors coupled to the memory wherein the one or more processors are configured to: include a plurality of single-port memories; couple a splitter to the plurality of single-port memories, wherein a data stream which is received is split by the splitter and written into the plurality of single-port memories and wherein bits are alternated such that even bits and odd bits are alternated among the plurality of single-port memories; couple a bit extractor which reads data from the plurality of single-port memories; and couple a scheduler which schedules reads and writes of the plurality of single-port memories to avoid conflicts. In some embodiments, a computer program product embodied in a non-transitory computer readable medium for circuit implementation may comprise: code for including a plurality of single-port memories; code for coupling a splitter to the plurality of single-port memories, wherein a data stream which is received is split by the splitter and written into the plurality of single-port memories and wherein bits are alternated such that even bits and odd bits are alternated among the plurality of single-port memories; code for coupling a bit extractor which reads data from the plurality of single-port memories; and code for coupling a scheduler which schedules reads and writes of the plurality of single-port memories to avoid conflicts.

Various features, aspects, and advantages of numerous embodiments will become more apparent from the following description.

### BRIEF DESCRIPTION OF THE DRAWINGS

The following detailed description of certain embodiments may be understood by reference to the following figures wherein:

FIG. 1 is a flow diagram showing data access.

FIG. 2 is a diagram showing natural and interleaved order data read.

FIG. 3 is a diagram showing single-port memory data organization for Radix-2.

FIG. 4 is a diagram showing address and data multiplexing.

FIG. 5 is a diagram showing single-port memory organization for Radix-4.

FIG. 6 is a timing diagram showing data packing

FIG. 7 is a flow diagram for design implementation.

FIG. 8 is a system diagram for design implementation.

### DETAILED DESCRIPTION

High-speed data handling is fundamental to many systems, including and in particular to communications systems. These systems must manipulate continuous or nearly continuous streams of data in such ways as to maximize efficiency. Here, efficiency refers not only to optimal data handing and to low power consumption, but also to maximizing data transmission via noisy or unreliable communications channels. Further, the data handling systems must be sufficiently flexible and scalable so as to be readily adaptable to a wide range of communications standards, for example. The present disclosure provides a description of various methods, systems, and apparatus associated with a low-power and scalable architecture for turbo encoding. Efficient data handling is critical to many applications including communications systems. However, other design requirements such as the handling of a continuous input data stream or providing a continuous output data stream (i.e. data streaming) necessitate architectural design decisions that consume considerable amounts of valuable chip real estate and demand more power. In addition, the control of such systems may be prohibitively complex, inflexible, and redundant.

Numerous data stream handling schemes exist that process data in various ways. These schemes have differing architectural and hardware requirements demanding various memory and control approaches. Since many of these systems find implementation in devices requiring power-efficient data processing, low power designs are necessary. Further, since design requirements continually evolve, easily and effectively scalable architectures are also highly desirable.

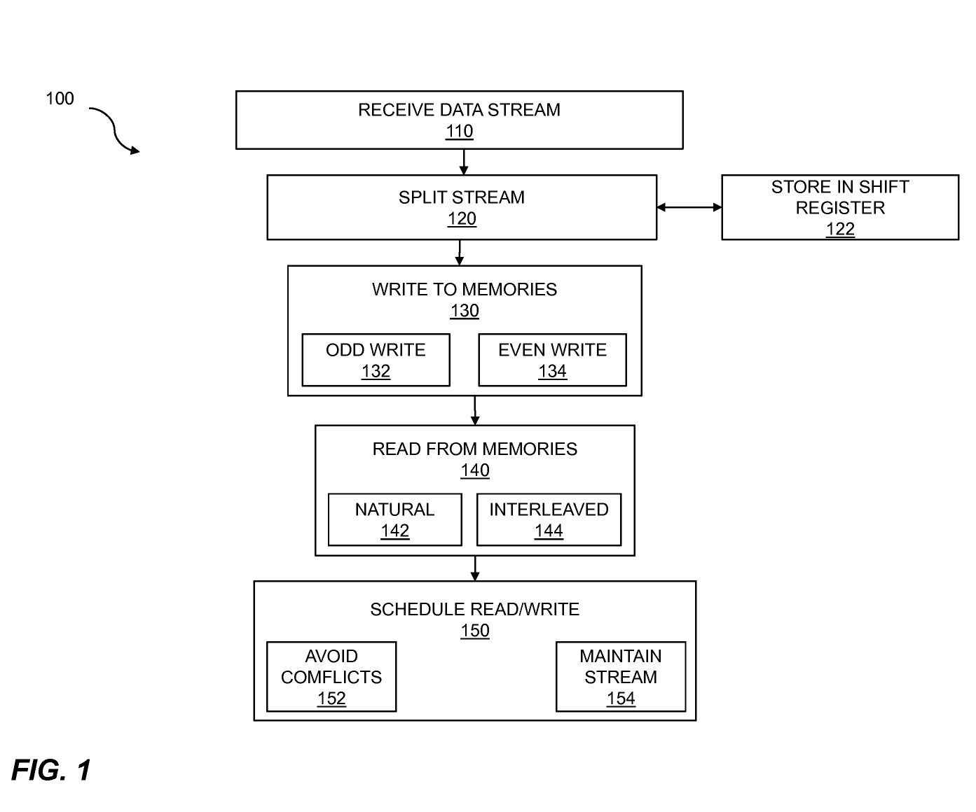

FIG. 1 is a flow diagram showing data access. A flow 100 is described for a computer-implemented method for data manipulation. Power efficient and scalable data manipulation systems are needed in communications and other data handling applications. Further, channel coding schemes are commonly implemented to improve data integrity, transmission efficiency, storage efficiency, security and the like. One such channel encoding scheme is called turbo code. Turbo codes implement a high performance Forward Error Correction (FEC) scheme and often find application in digital communications systems. Turbo codes have the ability to locate and correct bit errors in data that is transmitted, stored, and the like. Other coding schemes exist that may also be used for FEC purposes. However, the main advantage of turbo codes is their ability to achieve data transmission rates that may closely approach the Shannon maximum channel capacity of the communications system. That is, even given an unreliable and/or noisy signal, these codes may approach the maximum data transmission rate for a given bandwidth.

The flow 100 begins with receiving a data stream 110. The stream may include a communications stream. The data stream may be a series of bits, words, and the like, where the bits, words, and the like are part of the communications stream. The data from the stream may include encoding. The encoding technique employed on the data stream may be a turbo code. The encoding scheme and the choice thereof may be part of a communications system where the communications system may be one of 3GPP LTE, IEEE standard for LAN, and IEEE standard for MAN.

The flow 100 continues with splitting the data stream into a sequence of even bits and odd bits 120. The data stream comprises a series of bits with even address indices and bits with odd address indices. The data stream may be divided into blocks. Data packing may be performed on the data blocks into which the stream is divided by storing the bits in a plurality of single-port memories. The block size, into which the data stream is divided, is determined based on a communications standard. The communications system may be one of 3GPP LTE, IEEE standard for LAN, and IEEE standard for MAN. The bits with the even indices may be stored in a first shift register and the bits with the odd indices may be store in a second shift register 122 for subsequent writing to memories.

The flow 100 continues with performing data packing on data blocks into which a data stream may be divided. Data packing comprises writing data from a sequence of bits to a plurality of single-port memories as 8 bit, 16 bit, or other memory width data is packed where the writing alternates the even bits and the odd bits among the plurality of single-port memories 130. The memories may consist of a plurality of single-port memories. The blocks of data to be written consist of bits from the data stream. The writing of the data blocks into the single-port memories is accomplished using natural order, progressing through the memory locations sequentially (e.g. 0, 1, 2, 3, and so on). The bits may then be stored in a plurality of single-port memories including two single-port memories. The even bits and the odd bits may be stored in a natural order. The bits with even addresses may be stored in an even memory or memories, and the bits with odd addresses may be stored in an odd memory or memories. For example, bits with even indices may be written into a first single-port memory 134, and bits with odd indices may be written a second single-port memory 132. More than two single-port memories may be used to store bits with even indices and bits with odd indices. For example: 4, 8, or more single-port memories may be used. When two single-port memories are used, the two single-port memories are of size equal to one half a block size based on a communications standard.

The flow 100 continues with reading from the plurality of single-port memories where the reading gathers data bits from among the plurality of single-port memories 140. Data to be read is selected from the plurality of memories. Depending on the particular application, the data may be read simultaneously from the plurality of memories in the order in which the data was written, i.e. a nature order. The data may however be read in an interleaved order. For example, data selection may support the reading of the stream data in natural order 142 (0, 1, 2, 3, and so on). Similarly, data selection may support the reading of the stream data in interleaved order 144, alternating through memory locations, first selecting one memory and then another on the next read operation. As is the case in writing of the stream data into the memories, the reading of the data for the output stream may be based on an index which points to data in the two single-port memories or the plurality of single-port memories. Thus, for example with two single-port memories, data with even address indices may be read from a first single-port memory, and data with odd address indices may be read from a second single-port memory.

The flow 100 continues with scheduling the writing and reading operations 150 to avoid conflicts. The single-port memories must support multiple operations, including writing, reading in natural order, and reading in interleaved order. In order for the system to operate properly, various types of memory operation conflicts must be avoided 152. For example, a single-port memory will not support a write to and a read from the same memory address simultaneously. Instead, a read operation may cause a delay in a write operation in order to avoid a conflict 152. Data from a delayed write is backed up locally and then written to one of the plurality of memories later. No two operations may be supported by a single-port memory simultaneously because of the limitation of the single port. However, various memory access operations may be supported. The reading of the data for natural order addressing and the reading of the data for interleaved order addressing may occur simultaneously. The reading of the data for natural order addressing and the reading of the data for interleaved order addressing may occur in different memories among the plurality of memories, and the different memories may be comprised of an even memory and an odd memory. A read operation and a write operation may take place simultaneously when the read operation and the write operation occur in different memories among the plurality of memories, and when the different memories are comprised of an even memory and an odd memory. The read operation and the write operation may be requested simultaneously wherein the read operation and the write operation occur in the same memory among the plurality of single-port memories and wherein the write operation is delayed to a following cycle. An interleaved read operation may have priority over a natural read, which has priority over a write operation. A read operation may cause a delay in a write operation in order to avoid a conflict. Writing to and reading from the plurality of single-port memories may be scheduled such that the memories may support a continuous stream of input data, and such that the memories may support continuity, i.e. maintain the stream 154 of data, at the encoder's output. For example: if a write operation attempted to function at a memory address at which a read operation was requested, the write operation might be delayed until after the read operation completes—thus avoiding a conflict. Further, data from the delayed write operation may be backed up locally and then later written to one of the plurality of single-port memories. The input data stream may be continuous and the write operation may be delayed while a read operation occurs. Thus, the delay of a write operation by a read operation may enable continuity of data in the input stream. Similarly, the output data stream may be continuous and the write operation may be delayed while a read operation occurs in order to enable continuity of data in the output stream. To maintain continuous streaming at the output, write operations may be delayed whenever memory conflicts between write and read operation occurs.

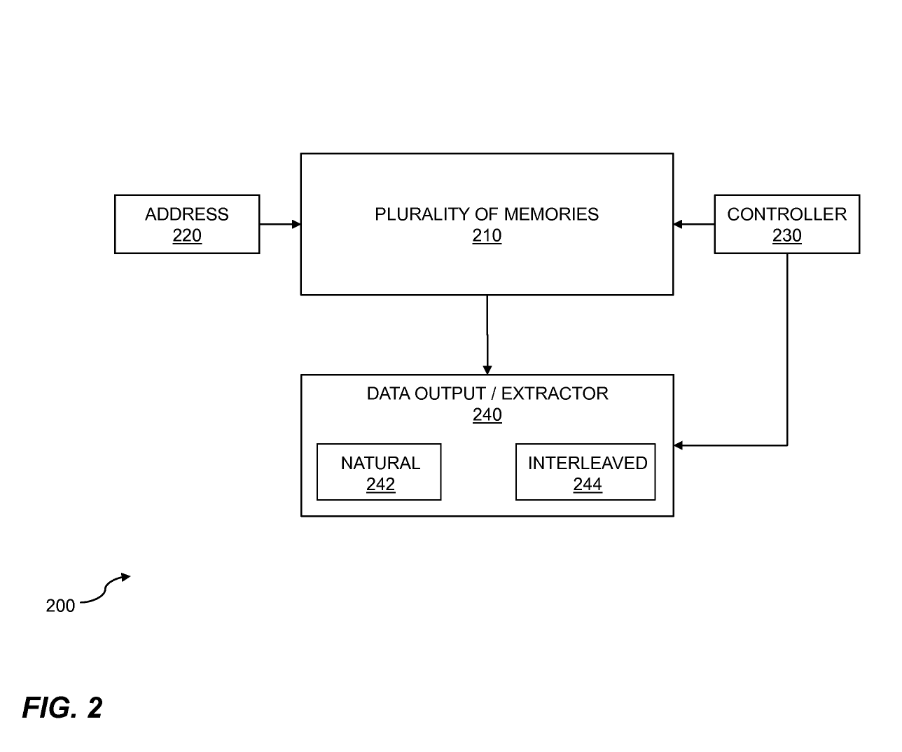

FIG. 2 is a diagram showing natural and interleaved order data read. A system 200 is shown for reading a data stream that was previously stored in a plurality of memories 210. In embodiments, the plurality of memories comprises two or more single-port memories. The stored data stream comprises bits, words or other input to, for example, a communications system. The data stream may have been divided into blocks. The blocks from the data stream may have been written into a plurality of single-port memories in natural order (0, 1, 2, 3, and so on).

Data to be read may be selected from the plurality of single-port memories 210. Access to the plurality of memories 210 requires an address 220. The address may refer to the index of bits stored in the plurality of memories 210. The address may comprise an even index which may select one of the plurality of single-port memories used to store bits or other data with even indices. Similarly, the address may comprise an odd index which may select one of the plurality of single-port memories used to store bits or other data with odd indices. In addition to an address 220 with is used to access the plurality of single-port memories 210, various controller 230 signals may be required. The controller 230 controls the various operations of the plurality of single-port memories. Control signals may comprise a read/write signal which in the instance of read operations would be set to indicate Read. Thus, data to be read may be selected from the plurality of memories.

Data is read from the plurality of memories 210 by the data output/extractor 240. The controller 230 may direct the data Output/Extractor 240 to perform data selection that may support the reading of the stream data in natural order 242, for example: 0, 1, 2, 3, and so on. In addition, the controller 230 may direct the Output/Extractor 240 to perform data selection that may support the reading of the stream data in interleaved order. In embodiments, reading of the data for natural order addressing and the reading of the data for interleaved order addressing may occur simultaneously. In embodiments, the controller 230 may ensure that an interleaved read operation may have priority over a natural read which in turn may have priority over a write operation.

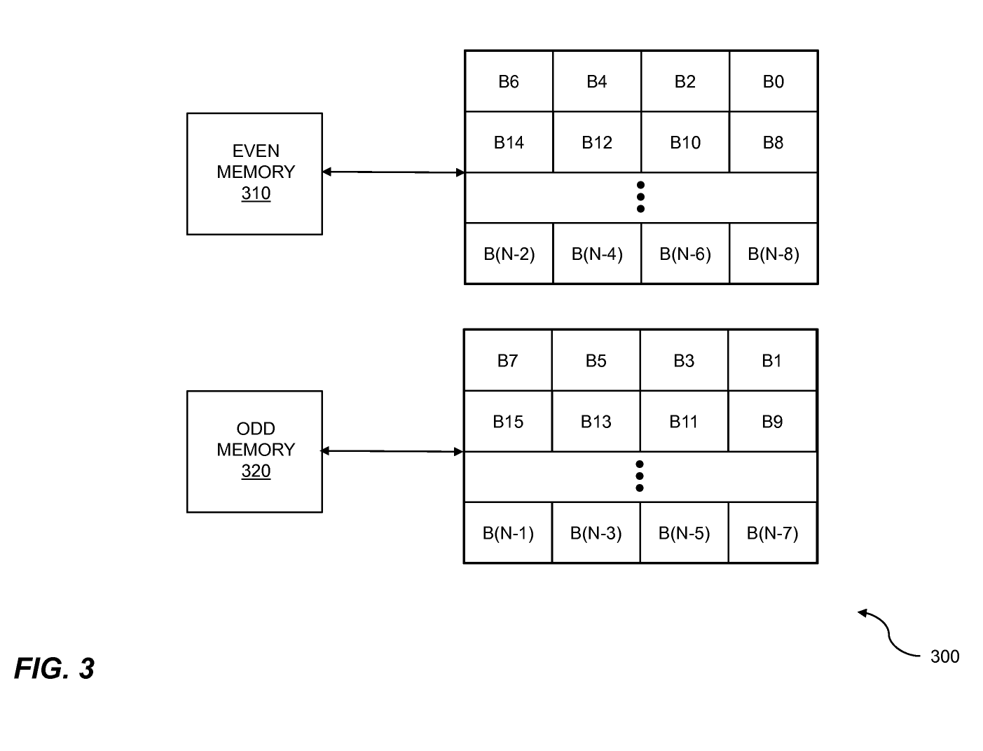

FIG. 3 is a diagram showing single-port memory data organization 300 for Radix-2. Bits, words or other data comprising a data stream may be divided from the data stream and may be stored in a plurality of single-port memories. In some embodiments, the plurality of memories may consist of two single-port memories. Data bits with even indices may be written into a first single-port memory 310 and bits with odd indices may be written into a second single-port memory 320. Using a communications system as an example, the two single-port memories may be of size equal to one half a block size based on an accepted communications standard. The writing of data blocks into the single-port memories 310 and 320 may be accomplished using natural order (i.e. 0, 1, 2, 3, and so on).

Consider as an example the writing in natural order of a data stream from a communications system with block size equal to N. In this case, the even memory 310 will be of size N/2, and the odd memory 320 will be of size N/2. Bits with even indices (0, 2, 4, 6 . . . N−2) will be written into the even memory 310, while bits with odd indices (1, 3, 5, 7 . . . N−1) will be written into the odd memory 320. Bit B0 is written into even memory 310, bit B1 is written into odd memory 320 continuing until the last even bit B(N−2) is written into the even memory 310, and the last odd bit B(N−1) is written into the odd memory 320. Thus, one full block of size N may be written in natural order across the two single-port memories 310 and 320 in a so-called “ping-pong” fashion alternating from one memory to the other and then back again. In most embodiments, the data is stored into shift registers and then written in byte-wide (or other width corresponding to the memory width) when the shift register is full. The length of the shift register will be equal to the width of the single port memory. For example, if the memory width is 4 bits, then the write to the even memory happens once in every 4 cycles.

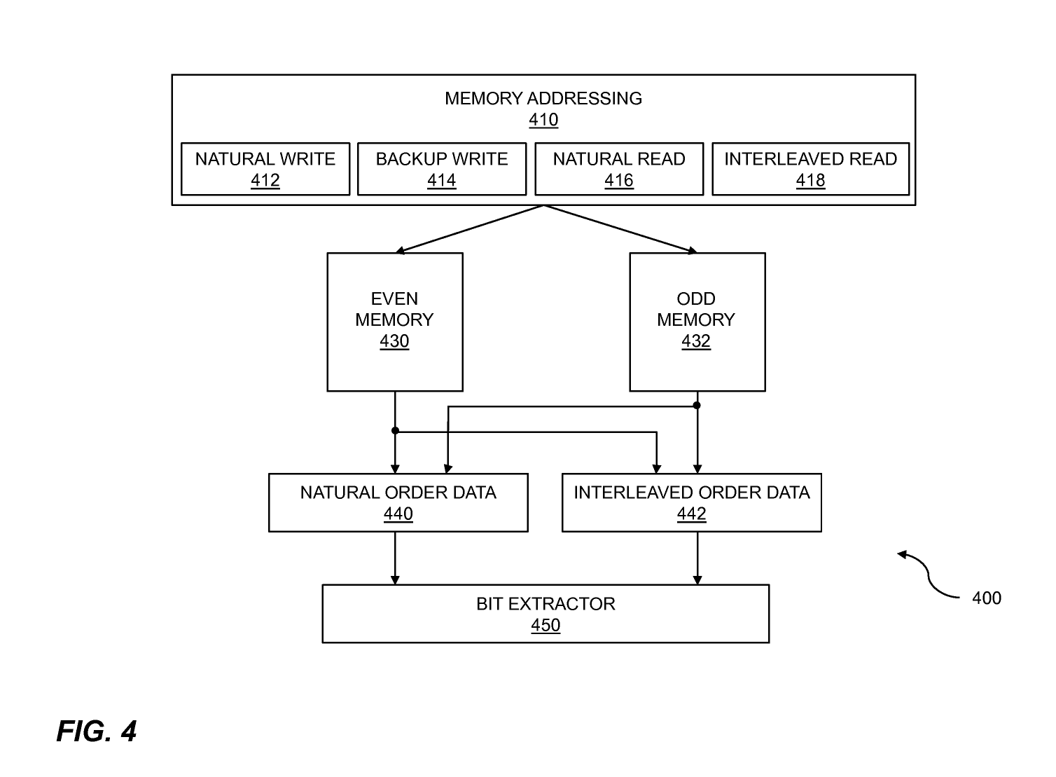

FIG. 4 is a diagram showing address and data multiplexing. Address and data multiplexing 400 comprises addressing of a plurality of memories 410. In embodiments, four types of memory addressing may be supported: addressing which may support the natural order writing 412 of bits, addressing which may support the storing of backed up write 414 bits, addressing which may support the natural order reading 416 of bits, and addressing which may support the interleaved order reading 418 of bits. Each of these addressing schemes 410 indicates which of the plurality of memories may be accessed for the purposes of reading and writing.

In the case of a natural write 412 or a backup write 414, blocks from a data stream may be written to a plurality of memories. In embodiments, the plurality of memories may comprise two single-port memories, an even memory 430, and an odd memory 432. Bits with even address indices are written into an even memory 430, and bits with odd address indices are written into an odd memory 432. The sizes of the even memory 430 and the odd memory 432 are based on the block size determined by a particular communications standard. For a particular communications standard, a block size may be N. In embodiments, two single-port memories are used, each of size N/2.

Data to be read from the stored block of the data stream is selected from the plurality of memories. In embodiments, data selected with even address indices may be read from an even memory 430, and data selected with odd address indices may be read from an odd memory 432. Data selection may support the reading of the stream data in natural order 440. Data selection may support the reading of the stream data in interleaved order 442. In embodiments, the reading of the data for natural order addressing and the reading of the data for interleaved order addressing may occur simultaneously. In embodiments, the reading of the data for natural order addressing and the reading of the data for interleaved order addressing may occur in different memories among the plurality of memories, and the different memories may be comprised of an even memory and an odd memory. In embodiments, a read operation and a write operation may take place simultaneously where the read operation and the write operation may occur in different memories among the plurality of memories, and where the different memories may be comprised of an even memories and an odd memory.

In embodiments, the order in which read and write operations occur is dependent upon the existence of a particular communications standard. An interleaved read operation may have priority over a natural read, which in turn may have priority over a write operation. A read operation may cause a delay in a write operation in order to avoid a conflict. In embodiments, when such a delay occurs, data from the write operation, which may be delayed, may be backed up locally and then may be written to one of the plurality of memories.

In embodiments, a bit extractor 450 may select bits from the natural order data 440 and also may select bits from the interleaved order data 442. The bit stream extractor 450 may supply a stream of data for a particular application such as a communications standard. As noted above, a read operation may cause a delay of a write operation. The delay of the write operation by the read operation may enable continuity of data in the input stream. In embodiments, the delay of the write operation by a read operation may enable continuity of data in the output stream.

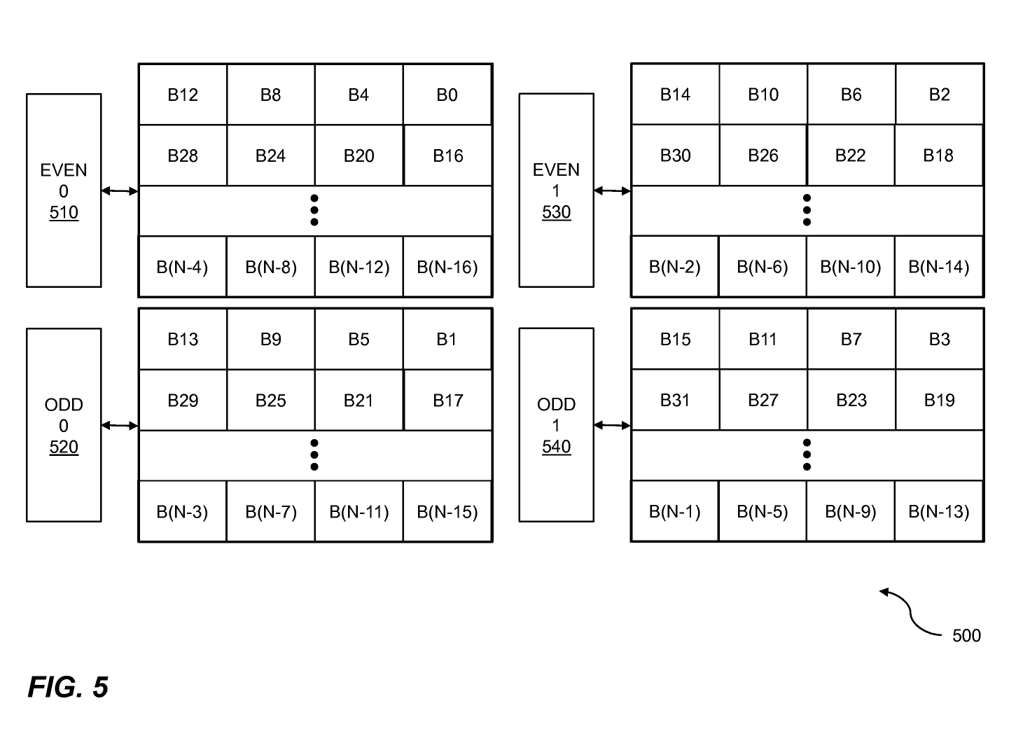

FIG. 5 is a diagram showing single-port memory organization 500 for Radix-4. As was the case for a system based on two single-port memories (Radix-2), bits, words or other data comprising a data stream may be divided from the data stream and may be stored in a plurality of single-port memories. In some examples, the plurality of memories may consist of two single-port memories such as that in FIG. 3, while in other embodiments, the bits may be stored in other numbers of single-port memories such as 4 (Radix-4) shown in diagram 500, 8 (Radix 8), 16 (Radix-16), or other numbers of single-port memories. Data bits with even indices may be written into the even single-port memories: Even 0 510 and Even 1 530; data bits with odd indices may be written into the odd single-port memories: Odd 0 520 and Odd 1 540. Using a communications system as an example, the four single-port memories may be equal in size to one quarter of a block size based on a given communications standard. The writing of data blocks into the single-port memories 510, 520, 530 and 540 may be accomplished using natural order (i.e. 0, 1, 2, 3, and so on).

Consider one embodiment for writing in natural order a data stream from a communications system with block size equal to N. The first even memory—Even 0 510—will be of size N/4, the second even memory—Even 1 530—will be of size N/4. The first odd memory—Odd 0 520—will be of size N/4, and the second odd memory—Odd 1 540—will be of size N/4. Bits with even indices (0, 2, 4, 6 . . . N−2) may, in this example for Radix-4, be split across the two even memories 510 and 530. Similarly, bits with odd indices (1, 3, 5, 7, . . . N−1) may, in this example for Radix-4, be split across the two odd memories 520 and 540. Thus, the bits with even indices that may be written into the first even memory Even 0 510 may be B0, B4, B8 . . . B(N−4). The bits with even indices that may be written into the second even memory Even 1 530 may be B2, B6, B10 . . . B(N−2). The bits with odd indices that may be written into the first odd memory Odd 0 520 may be B1, B5, B9 . . . B(N−3). The bits with odd indices that may be written into the second odd memory Odd 1 540 may be B3, B7, B11 . . . B(N−1). In embodiments, this “Ping-Pong” technique of writing data bits across a plurality of single-port memories may improve overall system performance be reducing read/write conflicts and by boosting data throughput rates.

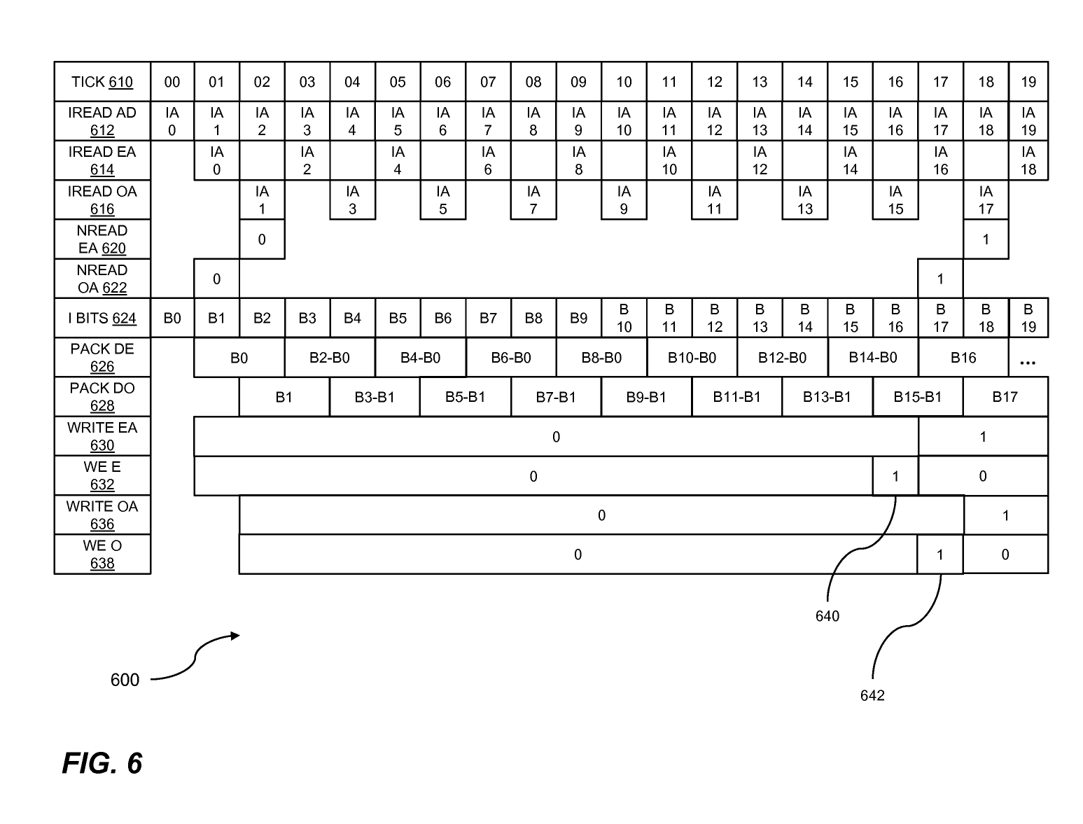

FIG. 6 is a timing diagram showing data packing. A timing diagram 600 is shown which illustrates various relationships among timing and data signals associated with the process of packing data ahead of writing two or more single-port memories. Data packing may be performed on data blocks into which the data stream may be divided. For example, data packing may allow data with even indices to be written into a first register, and data with odd indices to be written into a second register. In embodiments, four, eight, or more registers may be used in the writing process. The registers may be shift registers. When the registers have been filled with packed data, each may be written to a single-port memory. In some embodiments, one or more shift registers with even data indices may be written to one or more even index single-port memories, and one or more registers with odd data indices may be written to one or more odd index single-port memories. Examples of this writing of data may be seen in figures FIG. 3 and FIG. 5 described above.

The timing diagram 600 includes clock ticks 610. The clock ticks 610 may illustrate a local clock, a system clock, and the like. The clock ticks 610 may control how and when data may be packed into two or more registers before being written into two or more single-port memories. The interleaved read address IREAD AD 612 may show the address of data bytes that may be read in interleaved order. The clock ticks 610 may control the arrival of interleaved read addresses. The interleaved read addresses 612 may have even indices and odd indices. For example, addresses IA0, IA2, IA4 and so on, may be addresses with even indices, while addresses IA1, IA3, IA5 and so on, may be addresses with odd indices.

The interleaved read addresses may include interleaved read even addresses IREAD EA 614 and interleaved read odd addresses IREAD OA 616. The even and odd addresses may alternative based on the interleaved read address 612. In this manner, the addresses may Ping-Pong back and forth between even indices and odd indices.

The natural order read addresses may include natural order read even address NREAD EA 620 signals and natural order read odd address NREAD OA 622 signals. In embodiments, a natural order read may access data in an order such as B0, B1, B2 and so on where B0, B1, B2 . . . BN represent data stored in sequence. A natural order even indexed read address NREAD EA 620 may increment at the end of each block of data. So, for example, if a block size were 16, the even indexed read address 620 may then increment every 16 clock ticks. Similarly, a natural order odd indexed read address may then increment at the end of each block of data. So for example, if a block size were 16, the odd indexed read address may then increment every 16 clock ticks. Thus in the example of a natural order read, the address may not Ping-Pong back and forth between even indices and odd.

Input bits I BITS 624 may show the bits input to a data packing system. As the clock ticks advance, a stream of data bits may be processed. Packed byte-wise data using even indexed bits may be sent to an even memory using packed data even PACK DE 626, first stored in a register before they are written to a first of two or more single-port memories. So for example, packed data bytes with even addresses may accumulate over time in a shift register such as B0; then B2, B0; then B4, B2, B0 and so on until the shift register may be filled. Similarly, packed byte-wise data using odd indexed bits may be sent to an odd memory using packed data odd PACK DO 628, first stored in a register before they are written to a second of two or more single-port memories. So for example, packed data bytes with odd addresses may accumulate over time in a shift register such as B1; then B3, B1; then B5, B3, B1 and so on until the shift register may be filled.

A write even address WRITE EA 630 may indicate an address of a single-port memory into which a block of packed data is to be written. So for example, if a system were comprised of four single-port memories, two for storing even index data addresses and two for storing odd index data addresses, then the even memory write address may change after writing of a block of data to a single port memory. For example, WRITE EA 630 may be set to zero to indicate writing to a first single-port memory. After the first block of packed data may be written then the WRITE EA 630 may be set to one to indicate writing to a second single-port memory, and so on. Writing to even memories may be enabled by a write-enable even WE E 632 signal. Such a signal may normally be de-asserted, then later asserted 640 to indicate that a write is to be performed. Similarly, a write odd address WRITE OA 636 may indicate an address of a single-port memory into which a block of packed data is to be written. So for example, if a system were comprised of four single-port memories, two for storing even index data addresses and two for storing odd index data address, then the odd memory write address may change after writing of a block of data to a single port memory. For example, WRITE OA 636 may be set to zero to indicate writing to a first single-port memory. After the first block of packed data may be written then the WRITE OA 636 may be set to one to indicate writing to a second single-port memory. Writing to odd memories may be enabled by a write-enable odd WE O 638 signal. Such a signal may normally be de-asserted and then later asserted 642 to indicate that a write is to be performed.

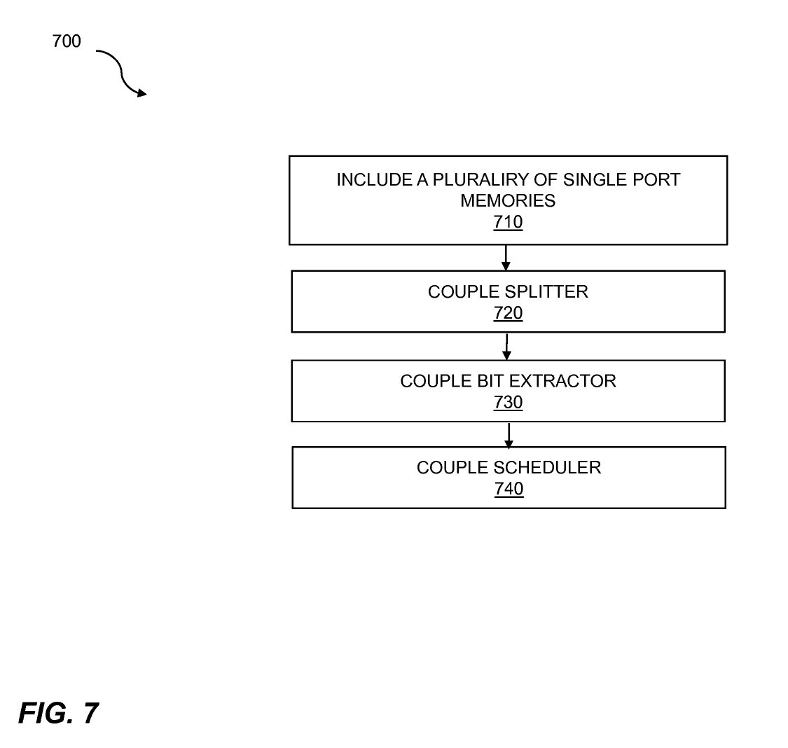

FIG. 7 is a flow diagram for design implementation. A flow 700 is described comprising including a plurality of single-port memories 710. The flow 700 may include coupling a splitter 720 to the plurality of single-port memories, wherein a data stream which is received is split by the splitter and written into the plurality of single-port memories and wherein bits are alternated such that even bits and odd bits are alternated among the plurality of single-port memories. The flow 700 may include coupling a bit extractor 730 which reads data from the plurality of single-port memories. The flow may include coupling a scheduler 740 which schedules reads and writes of the plurality of single-port memories to avoid conflicts. Various steps in the flow 700 may be changed in order, repeated, omitted, or the like without departing from the disclosed inventive concepts. Various embodiments of the flow 700 may be included in a computer program product embodied in a non-transitory computer readable medium that includes code executable by one or more processors.

Executing the flow 700 may result in apparatus for data manipulation comprising: a plurality of single-port memories; a splitter, coupled to the plurality of single-port memories, wherein a data stream which is received is split by the splitter and written into the plurality of memories so that bits are alternated among the plurality of single-port memories and wherein the bits are alternated such that even bits and odd bits are alternated among the plurality of single-port memories; a bit extractor which reads data from the plurality of single-port memories; and a scheduler which schedules reads and writes of the plurality of single-port memories to avoid conflicts.

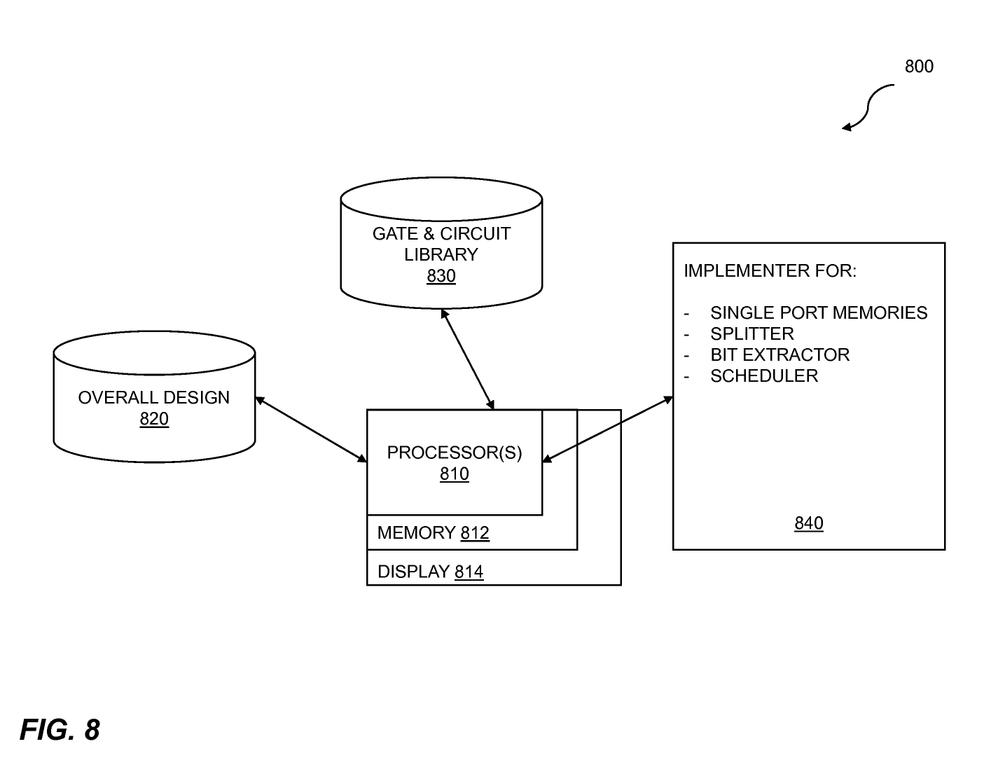

FIG. 8 is a system diagram for design implementation. A system 800 has a memory 812 for storing instructions, the overall design 820, gate and circuit library 830 information, system support, intermediate data, analysis, and the like, coupled to one or more processors 810. The one or more processors 810 may be located in any of one or more devices including a laptop, tablet, handheld, PDA, desktop machine, server, or the like. Multiple devices may be linked together over a network such as the Internet to implement the functions of system 800. The one or more processors 810 coupled to the memory 812 may execute instructions for implementing logic and circuitry, in support of data manipulation and encoding.

The system 800 may load overall design information 820, or a portion thereof, into the memory 812. Design information may be in the form of Verilog™, VHDL™, SystemVerilog™, SystemC™, or other design language.

The overall design may contain information about a data handling system such as a communications system. Similarly, system 800 may load gate and circuit library information 830 into the memory 812. The implementer 840 may use overall design information 820 and may use the gate and circuit library information 830 in order to implement a design. The design may comprise a plurality of memories and surrounding logic as part of a communications system. In at least one embodiment, the implementer 840 function is accomplished by the one or more processors 810.

The system 800 may include a display 814 for showing data, instructions, help information, design results, and the like. The display may be connected to the system 800, or may be any electronic display, including but not limited to, a computer display, a laptop screen, a net-book screen, a tablet computer screen, a cell phone display, a mobile device display, a remote with a display, a television, a projector, or the like.

The system 800 may contain code for including a plurality of single-port memories; code for coupling a splitter to the plurality of single-port memories, wherein a data stream which is received is split by the splitter and written into the plurality of single-port memories and wherein bits are alternated such that even bits and odd bits are alternated among the plurality of single-port memories; code for coupling a bit extractor which reads data from the plurality of single-port memories; and code for coupling a scheduler which schedules reads and writes of the plurality of single-port memories to avoid conflicts.

Each of the above methods may be executed on one or more processors on one or more computer systems. Embodiments may include various forms of distributed computing, client/server computing, and cloud based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above mentioned computer program products or computer implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the forgoing examples should not limit the spirit and scope of the present invention; rather it should be understood in the broadest sense allowable by law.

What is claimed is:

1. A computer-implemented method for data manipulation comprising:
receiving a data stream;
splitting the data stream into a sequence of even bits and odd bits;
writing data from the sequence of even bits and odd bits to a plurality of single-port memories wherein the writing alternates the even bits and the odd bits among the plurality of single-port memories;
reading from the plurality of single-port memories wherein the reading gathers data bits from among the plurality of single-port memories; and
scheduling the writing and reading operations to avoid conflicts.

2. The method of claim 1 wherein the data stream comprises a communications stream.

3. The method of claim 2 wherein the communications stream is one of 3GPP LTE, IEEE standard for LAN, and IEEE standard for MAN.

4. The method of claim 1 wherein the data stream includes encoding.

5. The method of claim 4 wherein the encoding includes a turbo code.

6. The method of claim 1 wherein the even bits and the odd bits are stored in a natural order.

7. The method of claim 1 wherein the data stream is divided into blocks.

8. The method of claim 7 wherein a block size, into which the data stream is divided, is determined based on a communications standard.

9. The method of claim 1 wherein the plurality of single-port memories comprises two single-port memories.

10. The method of claim 9 wherein the two single-port memories are of size equal to one half a maximum block size based on a communications standard.

11. The method of claim 1 wherein data packing is performed on data blocks into which the data stream is divided.

12. The method of claim 1 wherein bits with even indices are written into a first single-port memory and bits with odd indices are written into a second single-port memory.

13. The method of claim 12 wherein the bits with the even indices are stored a first shift register and the bits with the odd indices are stored in a second shift register.

14. The method of claim 1 wherein data selection reads the data stream in interleaved order.

15. The method of claim 1 wherein the reading of the data for natural order addressing and the reading of the data for interleaved order addressing occurs simultaneously.

16. The method of claim 1 wherein the reading of the data for natural order addressing and the reading of the data for interleaved order addressing occurs in different memories among the plurality of single-port memories and wherein the different memories are comprised of an even memory and an odd memory.

17. The method of claim 1 wherein a read operation and a write operation take place simultaneously wherein the read operation and the write operation occur in different memories among the plurality of single-port memories and wherein the different memories are comprised of an even memory and an odd memory.

18. The method of claim 1 wherein a read operation and a write operation are requested simultaneously wherein the read operation and the write operation occur in the same memory among the plurality of single-port memories and wherein the write operation is delayed to a following cycle.

19. The method of claim 1 wherein an interleaved read operation has priority over a natural read which has priority over a write operation.

20. The method of claim 1 wherein a read operation causes a delay in a write operation in order to avoid a conflict.

21. The method of claim 20 wherein data from the write operation, which is delayed, is backed up locally and then written to one of the plurality of single-port memories.

22. The method of claim 20 wherein the data stream is continuous and the write operation is delayed while a read operation occurs.

23. The method of claim 20 wherein an output data stream is continuous and the write operation is delayed while a read operation occurs.

24. An apparatus for data manipulation comprising:
a plurality of single-port memories;
a splitter, coupled to the plurality of single-port memories, wherein a data stream which is received is split by the splitter and written into the plurality of single-port memories so that bits are alternated among the plurality of single-port memories and wherein the bits are alternated such that even bits and odd bits are alternated among the plurality of single-port memories;
a bit extractor which reads data from the plurality of single-port memories; and
a scheduler which schedules reads and writes of the plurality of single-port memories to avoid conflicts.

25. A computer implemented method for circuit implementation comprising:
including a plurality of single-port memories;
coupling a splitter to the plurality of single-port memories, wherein a data stream which is received is split by the splitter and written into the plurality of single-port memories and wherein bits are alternated such that even bits and odd bits are alternated among the plurality of single-port memories;
coupling a bit extractor which reads data from the plurality of single-port memories; and
coupling a scheduler which schedules reads and writes of the plurality of single-port memories to avoid conflicts.

26. A computer system for circuit implementation comprising:
a memory which stores instructions;
one or more processors coupled to the memory wherein the one or more processors are configured to:
include a plurality of single-port memories;
couple a splitter to the plurality of single-port memories, wherein a data stream which is received is split by the splitter and written into the plurality of single-port memories and wherein bits are alternated such that even bits and odd bits are alternated among the plurality of single-port memories;
couple a bit extractor which reads data from the plurality of single-port memories; and
couple a scheduler which schedules reads and writes of the plurality of single-port memories to avoid conflicts.

27. A computer program product embodied in a non-transitory computer readable medium for circuit implementation comprising:
code for including a plurality of single-port memories;
code for coupling a splitter to the plurality of single-port memories, wherein a data stream which is received is split by the splitter and written into the plurality of single-port memories and wherein bits are alternated such that even bits and odd bits are alternated among the plurality of single-port memories;
code for coupling a bit extractor which reads data from the plurality of single-port memories; and
code for coupling a scheduler which schedules reads and writes of the plurality of single-port memories to avoid conflicts.
